(19) United States
(12) Patent Application Publication
(10) Pub. No.: US 2026/0018329 A1
(43) Pub. Date: Jan. 15, 2026

(54) Integrated Trans-inductor Electrical Components

(71) Applicant: Eaton Intelligent Power Limited, Dublin (IE)

(72) Inventors: Zhuo Min Liu, Pleasanton, CA (US); Chenghan Yang, Shanghai (CN); Xiaosu Zhao, Shanghai (CN)

(21) Appl. No.: 18/773,286

(22) Filed: Jul. 15, 2024

(51) Int. Cl. H01F 27/29; H01F 27/02; H01F 27/24; H01F 27/28

(52) U.S. Cl. CPC H01F 27/292; H01F 27/022; H01F 27/24; H01F 27/2804

(57) ABSTRACT

In one embodiment, a surface mount electromagnetic component for multi-phase electrical power circuitry implemented on a circuit board includes a first magnetic core, a second magnetic core structure, and an integrated winding. The integrated winding includes an inner winding and an outer winding, wherein the integrated winding is constructed by molding the inner winding and the outer winding, wherein the inner winding is electrically isolated from the outer winding, wherein the inner winding is nested in the outer winding, wherein the inner winding defines a first inverted U-shaped main winding portion, wherein the first inverted U-shaped main winding portion includes a first top section and first vertical legs perpendicular to the first top section, and wherein the outer winding defines a second inverted U-shaped main winding portion, wherein the second inverted U-shaped main winding portion includes a second top section and second vertical legs perpendicular to the second top section.

### TECHNICAL FIELD

This disclosure generally relates to electrical components.

### BACKGROUND

An inductor, also called a coil, choke, or reactor, is a passive two-terminal electrical component that stores energy in a magnetic field when electric current flows through it. An inductor typically consists of an insulated wire wound into a coil. Trans-inductor voltage regulators (TLVRs) allow engineers to improve on the transient response of their VRMs and meet the demanding load requirements of CPU, FPGAs, and ASICs in current and bandwidth without hurting other critical parameters. For engineers looking to rapidly implement a TLVR prototype, the single-secondary TLVR topology involves minimal risk given that the footprint of the TLVR inductors match with the standard single-turn inductor. This topology enables engineers to meet changing system requirements without sacrificing on cost, board space, and manufacturability.

With the increasing power level requirement for data centers, a new multiphase DC/DC voltage regulator using trans-inductor was released in the technical disclosure commons domain in 2019, and this new multiphase voltage regulator architecture has been adapting to the computing industry rapidly. The multiphase trans-inductor voltage regulator (TLVR) is an alternative circuit topology where the inductors in each of the phases becomes the secondary winding of a transformer and the primary winding is connected in a series loop with an additional compensation inductor (LC). This results in a fast transient response that matches the demands of the load in amperage and bandwidth without sacrificing any other critical parameters (e.g., board space, cost, efficiency, power density, etc.). The TLVR architecture allows end-users to benefit from the advantages of phase coupling, resulting in an extremely fast transient response that scales to the demands of the load in amps and bandwidth.

### SUMMARY OF PARTICULAR EMBODIMENTS

In particular embodiments, an integrated trans-inductor having a magnetic core and an integrated winding may be utilized to improve trans-inductor voltage regulators. The magnetic core may include two substantially E-shape core halves. The integrated winding may have an inner winding and an outer winding integrated using plastic molding prior to the assembly. The integrated winding may be coupled to the center post of the E-shape core. The integrated trans-inductor may employ three components, two core halves and an integrated winding. The integrated winding may be manufactured by using tooling which can be controlled precisely to resolve the hi-pot and coplanarity issues. The assembly process for the integrated trans-inductor may include only these three components and the manufacturing yield rate may be significantly high. Although this disclosure describes a trans-inductor in a particular manner, this disclosure contemplates a trans-inductor in any suitable manner.

In particular embodiments, a surface mount electromagnetic component for multi-phase electrical power circuitry may be implemented on a circuit board. The component may include a first magnetic core structure including a top side, a bottom side, opposing top and bottom walls and a longitudinal side. The component may also include a second magnetic core structure including a top side, a bottom side, opposing top and bottom walls and a longitudinal side. The component may additionally include an integrated winding including an inner winding and an outer winding. The integrated winding may be constructed by molding the inner winding and the outer winding. The inner winding may be electrically isolated from the outer winding. The inner winding may be nested in the outer winding. The inner winding may define a first inverted U-shaped main winding portion. The first inverted U-shaped main winding portion may include a first top section and first vertical legs perpendicular to the first top section. The outer winding may define a second inverted U-shaped main winding portion. The second inverted U-shaped main winding portion may include a second top section and second vertical legs perpendicular to the second top section.

In particular embodiments, molding the inner winding and the outer winding may be based on a nonconductive material suitable for injecting molding.

In particular embodiments, molding the inner winding and the outer winding may be based on a single molded clip including a clip pad, wherein a position of the clip pad is fixed.

In particular embodiments, each of the first and second magnetic core structures may have a length dimension a width dimension, and a height dimension relative to the circuit board. The height dimension may be substantially greater than the width dimension. In particular embodiments, the first or second inverted U-shaped main winding portion may extend in a plane defined by the height dimension and the length dimension.

In particular embodiments, the integrated winding may include a plurality of surface mount termination pads. The plurality of surface mount termination pads may include a first set of surface mount termination pads extending from the inner winding. The plurality of surface mount termination pads may include a second set of surface mount termination pads extending from the outer winding. In particular embodiments, the first set of surface mount termination pads may extend towards each other and the second set of surface mount termination pads extend away from each other. In particular embodiments, the plurality of surface mount termination pads may have a substantially same coplanarity.

In particular embodiments, each of the first and second modular magnetic core pieces may define a surface formed with slots to receive corresponding portions of the integrated winding. Each of the first and second modular magnetic core pieces may define a first surface and a second surface opposing first surface, each of the first and second surfaces including slots to receive portions of the integrated winding on the first surface and portions of the integrated winding on the second surface.

In particular embodiments, each of the first and second modular magnetic core pieces may be a flat and planar core piece.

In particular embodiments, the first and second modular magnetic core pieces may be identically sized and shaped but inverted relative to one another in a mirror-image arrangement on either side of the integrated winding.

In particular embodiments, each of the first and second modular magnetic core pieces may include a substantially E-shaped core halve. The integrated winding may be coupled to a center post of the E-shaped core halves.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

### BRIEF DESCRIPTION OF THE DRAWINGS

FIG. 1 illustrates an example exploded view of the integrated trans-inductor.

FIG. 2 illustrates an example integrated winding.

FIG. 3A illustrates an example integrated two-phase trans-inductor.

FIG. 3B illustrates an example architecture for integrating the integrated two-phase trans-inductor shown in FIG. 3A.

FIG. 4A illustrates an example integrated multiple-phase trans-inductor.

FIG. 4B-4C illustrate an example architecture for integrating the integrated multi-phase trans-inductor shown in FIG. 4A.

FIG. 5A illustrates a top view of an example molded clip.

FIG. 5B illustrates a cross sectional view of an example molded clip.

FIG. 5C illustrates an assembly of a molded clip.

FIG. 6A illustrates an example integrated molded clip.

FIG. 6B illustrates a bottom view of the integrated molded clip.

FIG. 6C illustrates a side view of the integrated molded clip.

FIG. 6D illustrates a correspondence between the side view and the bottom view of the integrated molded clip.

FIG. 7 illustrates an example flow chart describing the mold clip process.

FIG. 8 illustrates an example flow chart describing the pre-assembly clip process.

### DESCRIPTION OF EXAMPLE EMBODIMENTS

Traditional trans-inductor architecture may include a magnetic core and two windings, one primary and one secondary. The magnetic core may include two substantially E-shape halves. The two windings may include an inner winding and an outer winding. The inner winding may be coupled to the center post of the E-shape core, and the outer winding may be coupled to the inner winding. Inner winding may be electrically isolated from the outer winding. Inner winding may have two terminal pads, and outer winding may have two terminal pads. All the terminal pads, two from the inner winding and two from the outer winding, may have a substantially same coplanarity. Components for assembling a traditional trans-inductor may include two core halves, the inner winding, and the outer winding. Assembling these four components may not only take many steps but also need to be precise. Failures such as hi-pot failure, coplanarity failure, winding centering failure, and inductor tilting failure may often occur because of the many steps and many times of alignment. The manufacturing yield rate for traditional trans-inductors may be low.

The integrated trans-inductor disclosed herein may include two magnetic core halves and an integrated winding. The two core halves have a E-shape, the integrated winding may include an inner winding and an outer winding that are molded together using plastic. The inner winding may have two surface mount terminal pads, and the outer winding may have two surface mount terminal pads. The inner winding may be nested into the outer winding and may be molded together with the outer winding such that the inner winding and the outer winding are separated by the molding plastic and the inner winding and the outer winding including the pads are aligned both horizontally and vertically by tooling which assures the pads’ coplanarity.

Manufacturing the disclosed integrated trans-inductor may include assembling the integrated winding to the core only, which may significantly simplify the manufacturing process and enhance the manufacturing efficiency. The integrated trans-inductor may solve the hi-pot issues and the coplanarity issues. Further, the integrated trans-inductor may significantly improve the manufacturing efficiency.

In particular embodiments, two-phase and multiphase trans-inductors may be manufactured using the integrated winding to improve power density, reduce footprint, and improve multiphase voltage regulator current handing capability.

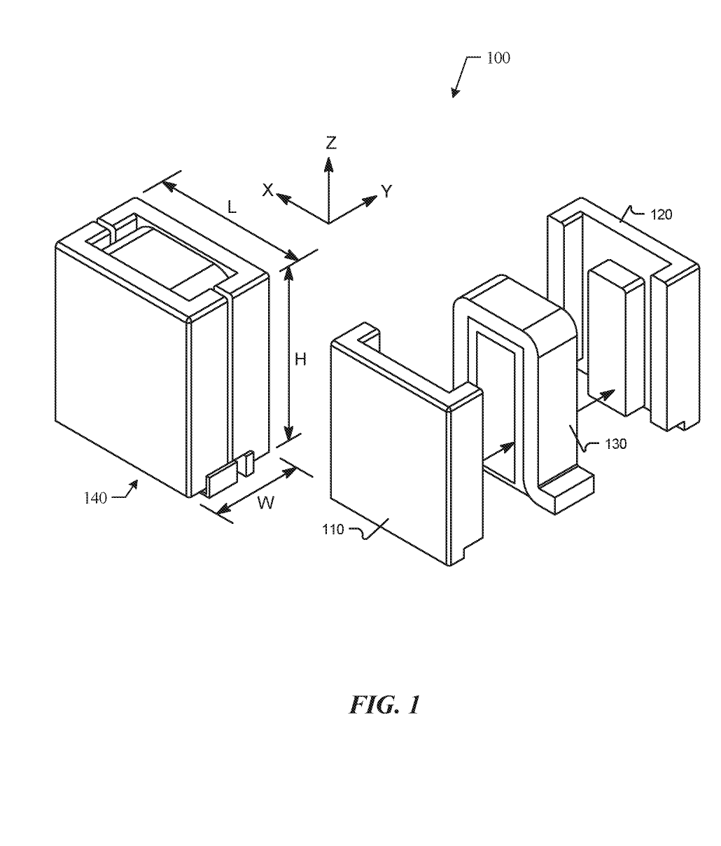

FIG. 1 illustrates an example exploded view of the integrated trans-inductor 100. The integrated trans-inductor 100 may include a first magnetic core structure 110, a second magnetic core structure 120, and an integrated winding 130. The first magnetic core structure 110 may be a substantially E-shaped core halve. Similarly, the second magnetic core structure 120 may be a substantially E-shaped core halve. The integrated trans-inductor 100 may be implemented on a circuit board, which may be configured with multi-phase power supply circuitry.

The first magnetic core structure 110 may be fabricated from a first magnetic core piece and the second magnetic core structure 120 may be fabricated from a second magnetic core piece. The first magnetic core structure 110 and the second magnetic core structure 120 may be assembled about the integrated winding 130. When assembled as shown by the arrows in FIG. 1, the first magnetic core structure 110 and the second magnetic core structure 120 in combination define the larger magnetic core structure 140 including a number of generally orthogonal side walls imparting an overall rectangular or box-like shape and appearance. The box-like shape of the magnetic core structure 140 in the illustrated example has an overall length L measured along a first dimensional axis such as an x axis of a Cartesian coordinate system, a width W measured along a second dimensional axis perpendicular to the first dimension axis such as a y axis of a Cartesian coordinate system, and a height H measured along a third dimensional axis extending perpendicular to the first and second dimensional axes such as a z axis of a Cartesian coordinate system. As shown, the height dimension H is much greater than the width dimension W and is slightly greater than the length dimension L.

The dimensional proportions in length, width and height dimensions of the magnetic core structure 140 runs counter to alternative approaches in the art to reduce the height dimension H as much as possible to produce a so-called low-profile component. In higher power, higher current circuitry, as the height dimension H is reduced the dimension W (and perhaps L as well) tends to increase to accommodate larger coil windings capable of performing in higher current circuitry. As a result, any reduction in height dimension H tends to increase the width W or length L and therefore increases the footprint of the component on a circuit board in the x, y plane of the circuit board. In contrast, the magnetic core structure 140 of the present disclosure, however, favors an increased height dimension H (and an increased component profile in the y, z plane measured perpendicular to the x, y plane of the circuit board) in favor of a smaller footprint on the circuit board in the x, y plane. Component density of the circuit board may accordingly be increased by virtue of the smaller footprint of the integrated trans-inductor 100 on the circuit board.

In particular embodiments, the magnetic core structure 140 may be assembled from the first magnetic core structure 110 and the second magnetic core structure 120, each fabricated utilizing ferrite material, or known soft magnetic particle materials and known techniques such as molding of granular magnetic particles to produce the desired shapes. Ferrite material may be used for the embodiments disclosed herein. Ferrite material may refer to a buck material that is derived from sintering of a mixture of MnO particles, ZnO particles, and Fe2O3 particles (with additives). Ferrite particle may refer to a particle that is grinded, or granulated from ferrite material. Soft magnetic powder particles used to fabricate the magnetic core pieces may include Ferrite particles, Iron (Fe) particles, Sendust (Fe–Si–Al) particles, MPP (Ni–Mo–Fe) particles, HighFlux (Ni–Fe) particles, Megaflux (Fe–Si Alloy) particles, iron-based amorphous powder particles, cobalt-based amorphous powder particles, and other suitable materials known in the art. In some cases, magnetic powder particles may be coated with an insulating material such that the magnetic core pieces may possess so-called distributed gap properties familiar to those in the art and fabricated in a known manner. The first magnetic core structure 110 and the second magnetic core structure 120 may be fabricated from the same or different magnetic materials and as such may have the same or different magnetic properties as desired.

The first magnetic core structure 110 and the second magnetic core structure 120 in the example of FIG. 1 are identically sized and shaped but inverted relative to one another in a mirror-image arrangement on either side of the integrated winding 130. Each of the first magnetic core structure 110 and the second magnetic core structure 120 therefore defines 50% or ½ of the magnetic core structure 140. In the example shown, each of the first magnetic core structure 110 and the second magnetic core structure 120 is formed in the shape of the exemplary modular magnetic core piece with opposing partial top and bottom walls and a longitudinal side wall interconnecting the top and bottom walls. The longitudinal side wall has height dimension H and length dimension L. More information on magnetic core structures may be found in U.S. Patent Application No. 12/763162, filed 19 April 2010, and U.S. Patent Application No. 17/358387, filed 25 June 2021, which is incorporated by reference.

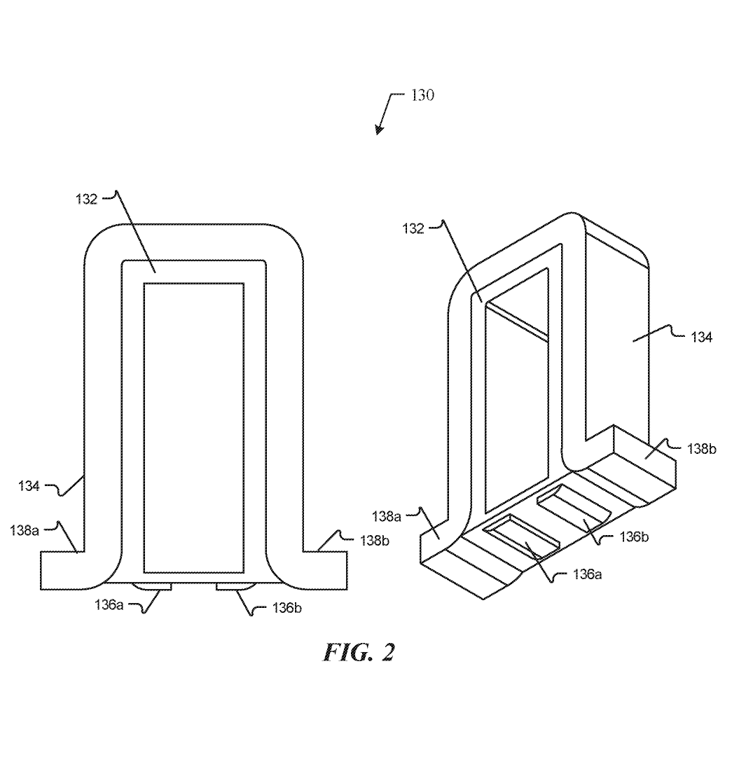

FIG. 2 illustrates an example integrated winding 130. The integrated winding 130 is constructed by molding an inner winding 132 and an outer winding 134 using injection molding. In particular embodiments, nonconductive materials usable for injection molding (i.e., with low viscosity at high temperatures) may be used for molding. Nonconductive material may be injected to the tooling cavities. Tooling may refer to tools, molds, of fixtures. As an example and not by way of limitation, plastic, e.g., liquid crystal polymer (LCP), may be injected between the inner winding 132 and outer winding 134 with the two windings not touching each other. The inner winding 132 and outer winding 134 are spaced apart from another but still close enough to one another. The inner winding 132 is electrically isolated from the outer winding 134. The inner winding 132 is nested in the outer winding 134. The inner winding 132 has two terminal pads 136, and the outer winding 134 has two terminal pads 138. All the terminal pads, two from the inner winding 132 and two from the outer winding 134, have a substantially same coplanarity.

The surface mount termination pads 136 and 138 may extend perpendicularly to an axis of the vertical legs in the integrated winding 130. The surface mount termination pads 136 associated with the inner winding 132 may extend toward a vertical axis in the middle of the integrated winding 130. By contrast, the surface mount termination pads 138 associated with the outer winding 134 may extend away from the vertical axis in the middle of the integrated winding 130. The surface mount termination pads 136 and 138 can help mount the integrated trans-inductor 100 to the surface of the circuit board using known soldering processes.

The inner winding 132 may be fabricated using a known conductive material such a metal or metal alloy familiar to those in the art. Similarly, the outer winding 134 may be fabricated using a known conductive material such a metal or metal alloy familiar to those in the art. The integrated winding 130 in the example shown is formed with a U-shaped main winding portion including elongated vertically extending leg sections that are received in the slots of the modular magnetic core piece, and a shorter top section extending generally perpendicular to the vertical leg elements and that is received in the horizontal slot in the modular magnetic core piece.

The outer winding 134 may be fabricated from a relatively thick elongated conductor that may for example, be cut or stamped as an axially elongated strip from a larger and generally planar piece of electrically conductive material. The axially elongated strip of material is then bent out of plane into the geometry shown including a three-dimensional inverted U-shaped main winding portion. Along the axis of the conductor, the inverted U-shaped main winding portion is defined by vertically extending parallel legs spaced apart but extending parallel to one another with a top section interconnecting the vertically extending legs in a perpendicular manner. Out of plane 90° bends transition the thick strip of conductive material between the mutually perpendicular vertical legs and the top section of the U-shaped main winding portion. The vertical legs of the inverted U-shaped main winding portion in the outer winding 134 each extend axially in the conductor in a direction parallel to the y, z plane relative to the circuit board (i.e., perpendicular to the major surface of the circuit board) while the top section extends axially in a direction parallel to the x, y plane of the circuit board (i.e., parallel to the major surface of the circuit board).

In contrast to the outer winding 134, the inner winding 132 is stamped from a relatively thin and planar sheet of conductive material into an inverted U-shaped main winding portion including vertical legs and a top section residing in the same plane. Unlike the outer winding 134, the inverted U-shaped main winding portion in the inner winding 132 includes co-planar vertical legs and top section, and consequently there are no out-of-plane bends in the inner winding 132 where the vertical and horizontal portions of the windings intersect. That is, the intersecting portions of the legs and top section in the U-shaped main winding portion of the inner winding 132 extend in the same plane as the legs and the top section.

The integrated winding 130 is rather simply shaped and may therefore be fabricated at relatively low cost. The modular magnetic core piece 140 that is used as the magnetic core pieces 110, 120 is likewise rather simply shaped and may be fabricated at low cost. The integrated winding 130 may be fabricated in advance as a separate element for assembly with the modular magnetic core pieces described. That is, the integrated winding 130 may be pre-formed in the shape as shown for later assembly with the magnetic core pieces. The U-shaped main winding portion in the inner winding 132 or the outer winding 134 defines less than one complete turn in the main winding portions in the magnetic core and is therefore less complicated to manufacture.

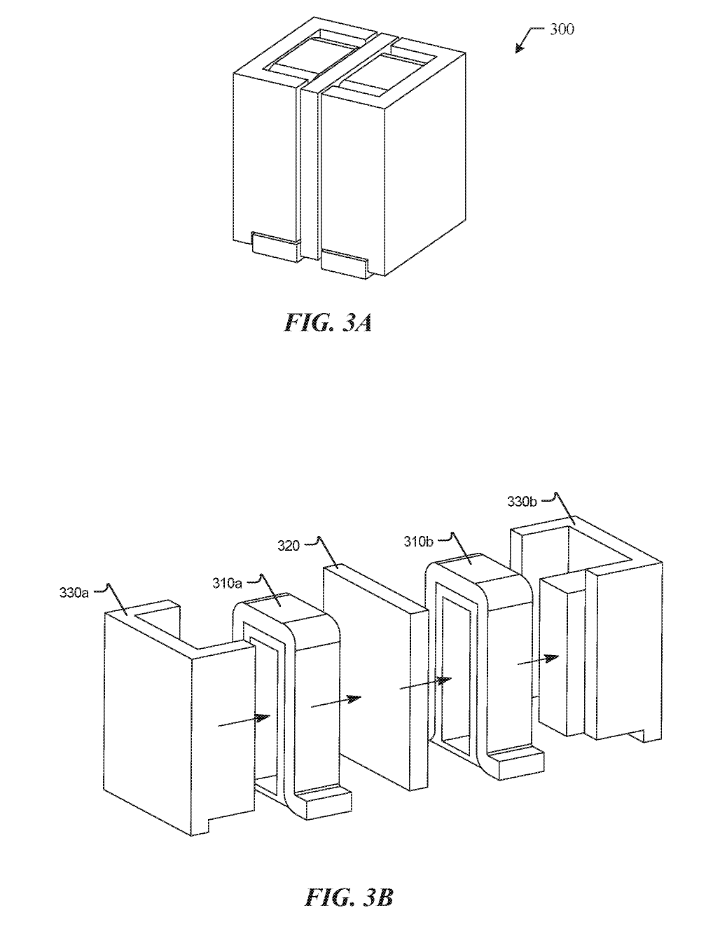

FIG. 3A illustrates an example integrated two-phase trans-inductor 300. FIG. 3B illustrates an example architecture for integrating the integrated two-phase trans-inductor shown in FIG. 3A. Manufacturing an integrated two-phase trans-inductor using the traditional trans-inductor architecture may be challenging because it includes four windings, and the assembly and alignment of these four windings can be very difficult. The presently disclosed integrated two-phase trans-inductor employs two integrated windings, i.e., integrated winding 310a and integrated winding 310b as illustrated in FIG. 3B. Each of the integrated windings 310 has pre-aligned terminal pads, which makes the assembly and alignment much easier and much more robust. The integrated two-phase trans-inductor 300 may additionally include an I-shape core 320, and two substantially E-shape cores 330. It is understood that more than two integrated windings may be integrated based on the architecture illustrated in FIG. 3B. An integrated multiphase trans-inductor may include multiple integrated windings and associated E-shape cores and I-shape cores, similar to the disclosed integrated two-phase trans-inductor 300.

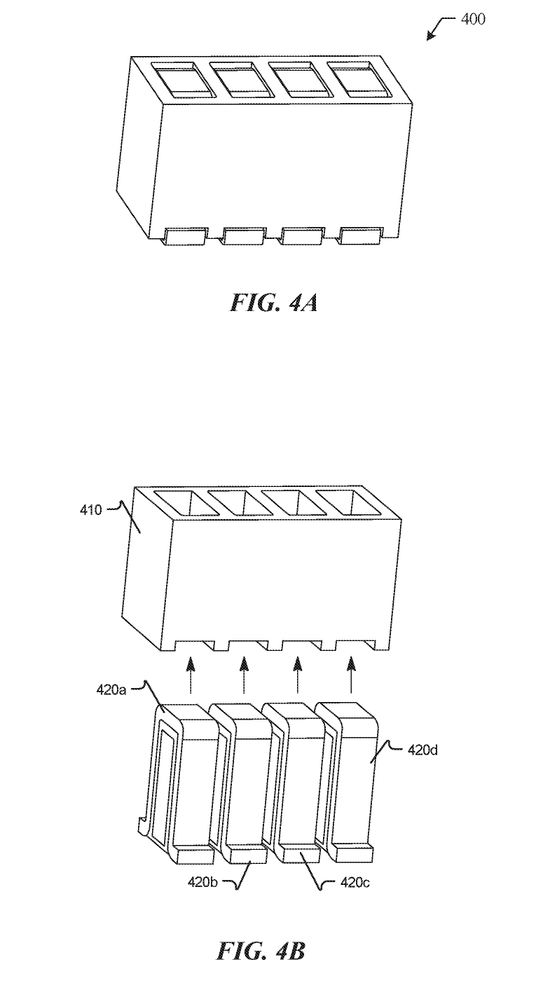

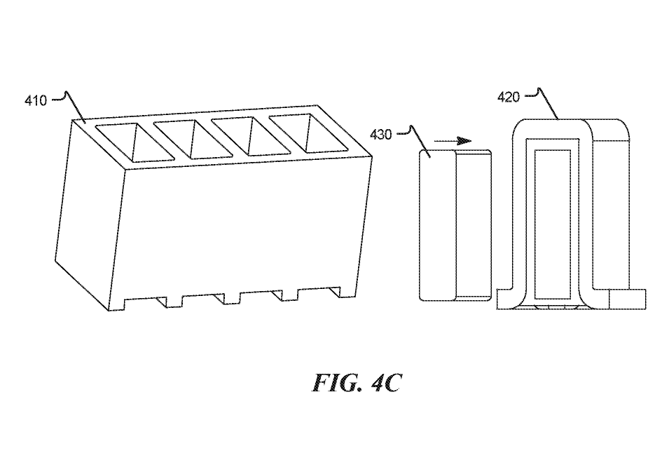

FIG. 4A illustrates an example integrated multiple-phase trans-inductor 400. FIG. 4B-4C illustrate an example architecture for integrating the integrated multi-phase trans-inductor shown in FIG. 4A. The integrated multiphase trans-inductor 400 may include a multi-cavity core 410, multiple integrated windings 420, and multiphase I-shape cores 430 assembled to the multiple integrated windings 430.

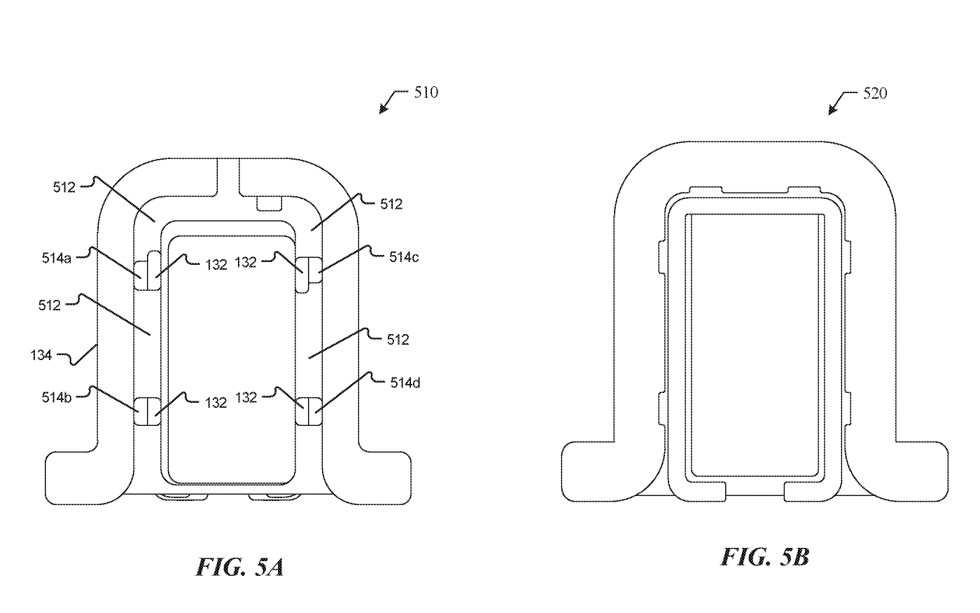

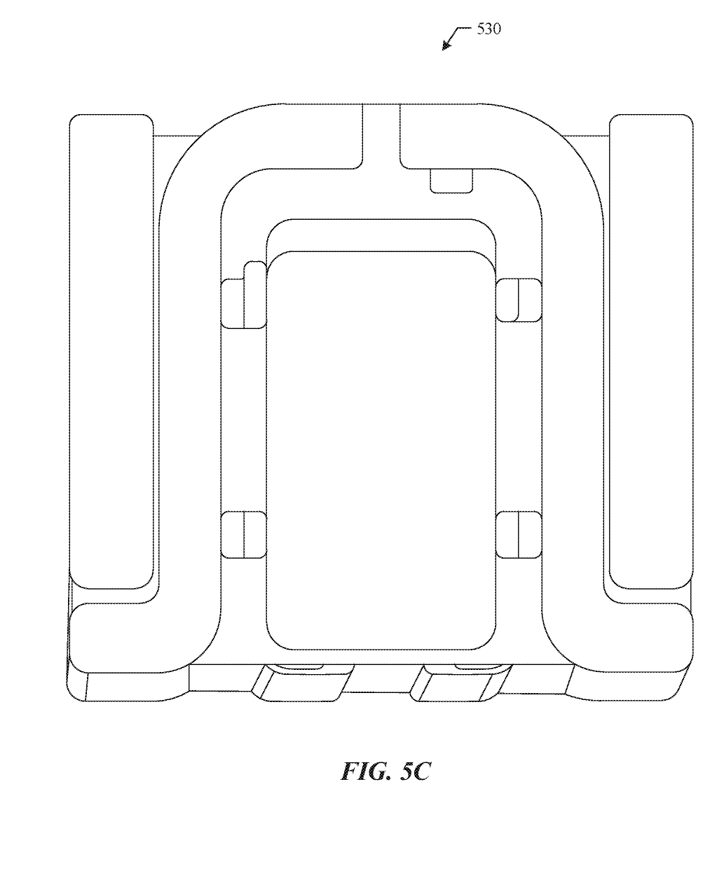

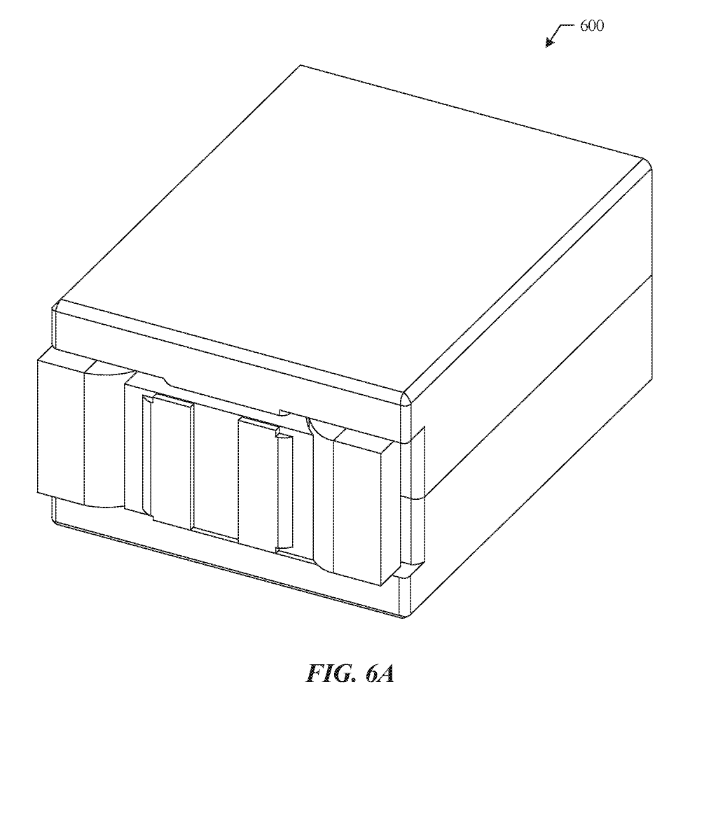

The inner winding 132 and outer winding 134 may be molded together using a molded clip. FIG. 5A illustrates a top view 510 of an example molded clip. In FIG. 5A, the inner winding 132 is not completely shown as it is mostly covered by plastic molding 512. The inner winding 132 is partially visible. There are gaps 514 between the inner winding 132 and outer winding 134. FIG. 5B illustrates a cross sectional view 520 of an example molded clip. FIG. 5C illustrates an assembly 530 of a molded clip.

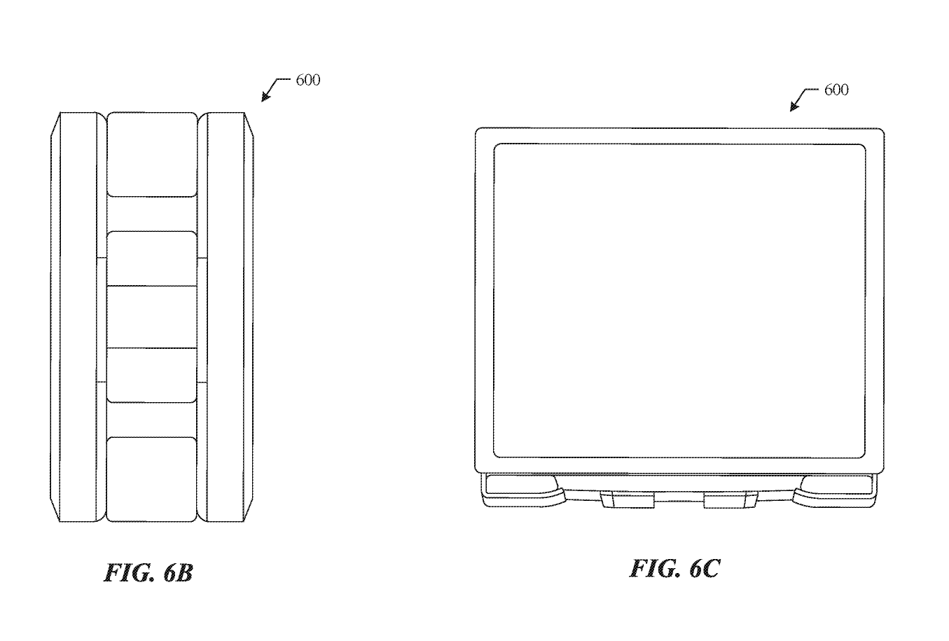

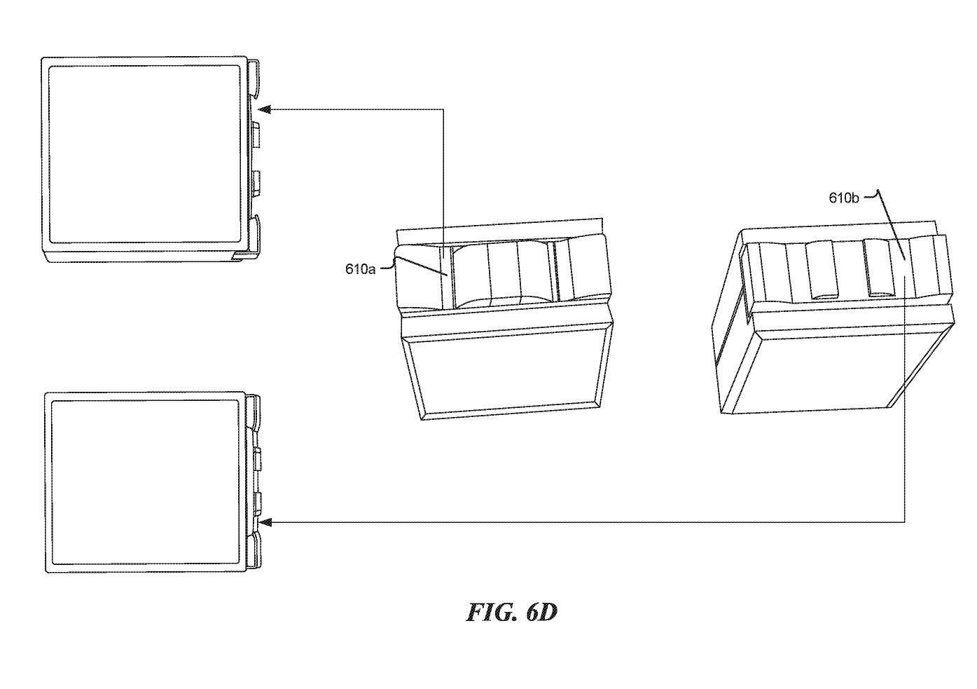

FIG. 6A illustrates an example integrated molded clip 600. The integrated molded clip 600 may integrate two clips as a whole with insulation material at the bottom of the molded clip 600. As a result, the integrated molded clip 600 may solve the hi-pot issue and coplanarity issue. In addition, the clip pad position may be relatively fixed. The integrated molded clip may be considered an assembly, which may result in increase of production capacity. FIG. 6B illustrates a bottom view of the integrated molded clip 600. FIG. 6C illustrates a side view of the integrated molded clip 600. FIG. 6D illustrates a correspondence between the side view and the bottom view of the integrated molded clip 600. As can be seen, particular embodiments may implement a shallow and small slot 610 next to the inner clip to better control the coplanarity.

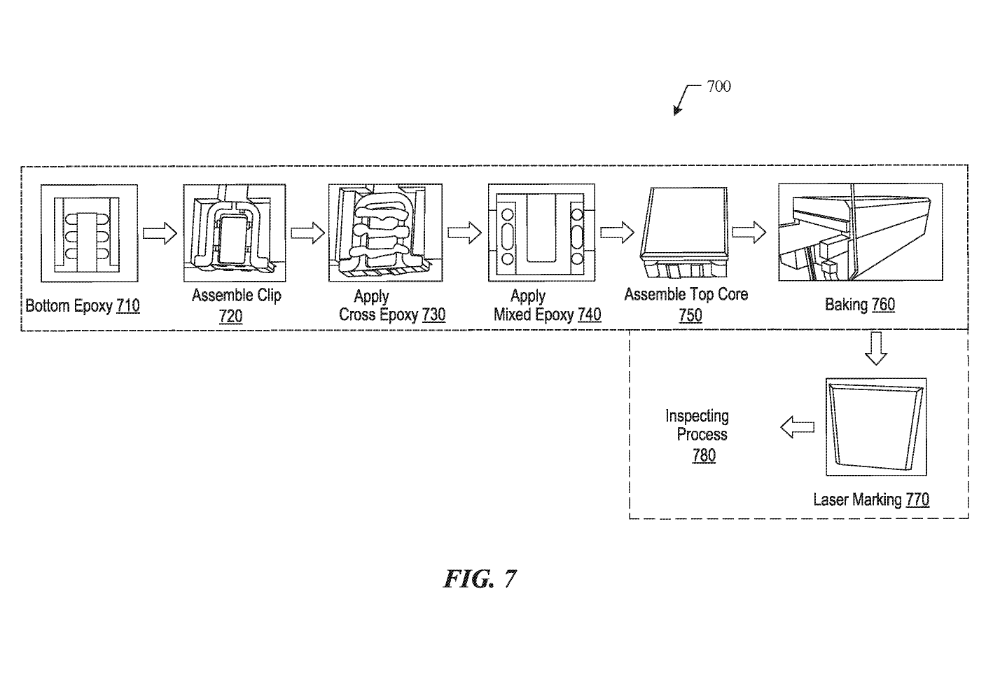

FIG. 7 illustrates an example flow chart 700 describing the mold clip process. At step 710, a bottom epoxy may be applied. At step 720, the clip may be assembled. At step 730, a cross epoxy may be applied. At step 740, a mixed epoxy may be applied. At step 750, the top core may be assembled. At step 760, the assembly may go through baking. At step 770, the assembly may go through laser marking. At step 780, the assembly may go through inspecting process.

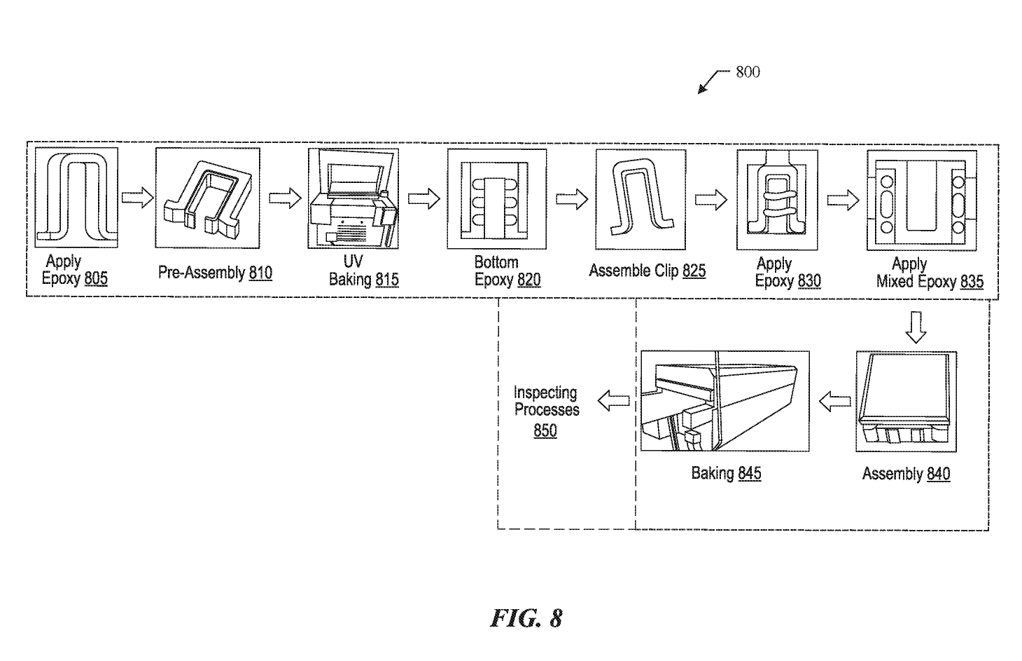

FIG. 8 illustrates an example flow chart 800 describing the pre-assembly clip process. At step 805, an epoxy (e.g., UV epoxy) may be applied. At step 810, the pre-assembly may be conducted. At step 815, the pre-assembly may go through UV baking. At step 820, a bottom epoxy may be applied. At step 825, the clip may be assembled. At step 830, the epoxy may be applied. At step 835, mixed epoxy may be applied. At step 840, the assembly may be produced. At step 845, the assembly may go through baking. At step 850, the assembly may go through inspecting processes.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A surface mount electromagnetic component for multi-phase electrical power circuitry implemented on a circuit board, the component comprising:
a first magnetic core structure including a top side, a bottom side, opposing top and bottom walls and a longitudinal side;
a second magnetic core structure including a top side, a bottom side, opposing top and bottom walls and a longitudinal side; and
an integrated winding comprising an inner winding and an outer winding,
wherein the integrated winding is constructed by molding the inner winding and the outer winding,
wherein the inner winding is electrically isolated from the outer winding,
wherein the inner winding is nested in the outer winding,
wherein the inner winding defines a first inverted U-shaped main winding portion, wherein the first inverted U-shaped main winding portion includes a first top section and first vertical legs perpendicular to the first top section, and
wherein the outer winding defines a second inverted U-shaped main winding portion, wherein the second inverted U-shaped main winding portion includes a second top section and second vertical legs perpendicular to the second top section.

2. The electromagnetic component of claim 1, wherein molding the inner winding and the outer winding is based on a nonconductive material suitable for injecting molding.

3. The electromagnetic component of claim 1, wherein molding the inner winding and the outer winding is based on a single molded clip comprising a clip pad, wherein a position of the clip pad is fixed.

4. The electromagnetic component of claim 1, wherein each of the first and second magnetic core structures has a length dimension a width dimension, and a height dimension relative to the circuit board; and
wherein the height dimension is greater than the width dimension.

5. The electromagnetic component of claim 4, wherein the first or second inverted U-shaped main winding portion extends in a plane defined by the height dimension and the length dimension.

6. The electromagnetic component of claim 1, wherein the integrated winding comprises a plurality of surface mount termination pads.

7. The electromagnetic component of claim 6, wherein the plurality of surface mount termination pads comprise a first set of surface mount termination pads extending from the inner winding, and wherein the plurality of surface mount termination pads comprise a second set of surface mount termination pads extending from the outer winding.

8. The electromagnetic component of claim 7, wherein the first set of surface mount termination pads extend towards each other.

9. The electromagnetic component of claim 7, wherein the second set of surface mount termination pads extend away from each other.

10. The electromagnetic component of claim 6, wherein the plurality of surface mount termination pads have a same coplanarity.

11. The electromagnetic component of claim 1, wherein each of the first and second magnetic core structures defines a surface formed with slots to receive corresponding portions of the integrated winding.

12. The electromagnetic component of claim 11, wherein each of the first and second magnetic core structures defines a first surface and a second surface opposing first surface, each of the first and second surfaces including slots to receive portions of the integrated winding on the first surface and portions of the integrated winding on the second surface.

13. The electromagnetic component of claim 1, wherein each of the first and second magnetic core structures is a flat and planar core piece.

14. The electromagnetic component of claim 1, wherein the first and second magnetic core structures are identically sized and shaped but inverted relative to one another in a mirror-image arrangement on either side of the integrated winding.

15. The electromagnetic component of claim 1, wherein each of the first and second magnetic core structures comprises an E-shaped core halve.

16. The electromagnetic component of claim 15, wherein the integrated winding is coupled to a center post of the E-shaped core halves.

17. An integrated winding configured for assembly in a surface mount electromagnetic component, the integrated winding comprising:
an inner winding; and
an outer winding;
wherein the integrated winding is constructed by molding the inner winding and the outer winding;
wherein the inner winding is nested in the outer winding;
wherein the inner winding defines a first inverted U-shaped main winding portion, wherein the first inverted U-shaped main winding portion includes a first top section and first vertical legs perpendicular to the first top section;
wherein the outer winding defines a second inverted U-shaped main winding portion, wherein the second inverted U-shaped main winding portion includes a second top section and second vertical legs perpendicular to the second top section.

18. The integrated winding of claim 17, wherein molding the inner winding and the outer winding is based on a nonconductive material suitable for injecting molding.

19. The integrated winding of claim 17, wherein molding the inner winding and the outer winding is based on a single molded clip comprising a clip pad, wherein a position of the clip pad is fixed.

20. The integrated winding of claim 17, further comprising a plurality of surface mount termination pads.
